(19) United States
(12) Patent Application Publication
(10) Pub. No.: US 2005/0146138 A1
(43) Pub. Date: Jul. 7, 2005

(54) Coolant hose for the transport from a reservoir vessel to a cooling chamber and a system for providing coolant to a cooling chamber

(75) Inventors: Rainer Wogritsch, Vienna (AT); Anton Lang, Vienna (AT)

Correspondence Address: S. Peter Konzel, Esq.;Simpson & Simpson, PLLC, 5555 Main Street, Williamsville, NY, 14221, US

(73) Assignee: Leica Mikrosysteme GmbH, Vienna (AT)

(21) Appl. No.: 11/021,390

(22) Filed: Dec. 23, 2004

(30) Foreign Application Priority Data
Jan. 7, 2004 (DE) 102004001280.6-13

(51) Int. Cl. F16L 33/18

(52) U.S. Cl. 285/361; 285/396

(57) ABSTRACT

A coolant hose for the transport of coolant from a reservoir vessel to a cooling chamber is disclosed. The coolant hose is constructed from a transport hose and an insulating casing. The first and the second end of the coolant hose are respectively provided with a rotatable and thermally insulated connecting element that coacts with a corresponding connecting element on the cooling chamber and on the reservoir vessel.

### CROSS REFERENCE TO RELATED APPLICATIONS

This application claims priority of German Patent Application No.: 10 2004 001 280.6, which is incorporated by reference herein.

### FIELD OF THE INVENTION

The invention concerns a coolant hose for the transport of coolant from a reservoir vessel to a cooling chamber.

Furthermore, the invention concerns a system for providing coolant to a cooling chamber.

### BACKGROUND OF THE INVENTION

The hoses used at present comprise an internally located polyamide hose having an inside diameter of 4-6 mm and an insulating sponge-rubber hose, located thereabove, of the Armaflex company. An approximately 10-20 mm insulating layer of the sponge-rubber hose is sufficient to bring the outside temperature into the positive temperature range (approximately room temperature). This hose combination is used to connect a reservoir vessel, having a pump placed therein, to a preparation chamber or a cooling chamber.

For attachment of the hose to a preparation chamber as described e.g. in the Leica EM CPC brochure, or to a cooling chamber for an ultramicrotome as described e.g. in the Leica EM FCS brochure, or to the pump, the inner hose (polyamide) is slid onto a metal tube. The hose contracts more than the metal tube upon cooling, thus, enabling a leakproof join.

In order to eliminate problems with these attachments, RMC (see RMC “Ultramicrotomes” brochure) secured the hose nondisengageably to the nitrogen pump. The connection to the cooling chamber was configured in such a way that a bracing of the hose against the table is present, holding the hose in a specific position so that while no mechanical connection to the chamber exists, nitrogen drips into an opening of the cooling chamber located therebelow.

The connection of the Leica devices to the reservoir vessel has the great disadvantage that it is not disengageable at low temperatures because of the contraction of the inner hose. This is sometimes necessary, however, for example when the reservoir vessel becomes empty during preparation and the pump is no longer delivering. The pump needs to be rapidly inserted into another, full reservoir vessel. A cold hose cannot be disengaged at the connecting points, and is also not flexible enough when cold. Breakage of the hose is often the consequence when an attempt is made to lift the pump, with the cold hose attached, out of the Dewar or reservoir vessel.

With the device of the RMC company, disengagement of the hose is not necessary. Other disadvantages must be accepted, however. Because of the absence of a secure connection between hose and cooling chamber, it becomes the user's responsibility to carefully align the hose outlet with the opening in the chamber. This is made more difficult by the circumstance that the hose deforms upon cooling and the alignment is modified. The consequence of a misalignment is that liquid nitrogen runs along the worktable into the laboratory. Damage to the laboratory, and injury to users, are possible.

### SUMMARY OF THE INVENTION

It is therefore the object of the present invention to create an insulated hose, as used hitherto, with which a rapid attachment and connection between two devices can be produced. It should moreover also be possible to disengage the hose, easily and without damage, at low temperatures. The hose should moreover also be usable as an integral hose for all devices.

This object is achieved by a coolant hose for the transport of coolant from a reservoir vessel to a cooling chamber, comprises a transport hose with an insulating casing, a first and a second end is provided with the coolant hose, a rotatable and thermally insulated connecting element is provided on the first and the second end of the coolant hose each of which coacts with a corresponding connecting element on the cooling chamber and on the reservoir vessel.

It is an additional object of the present invention to provide a system for transporting coolant to a cooling chamber, which allows rapid attachment and connection.

This object is achieved by a system for providing coolant to a cooling chamber, comprising: a reservoir vessel, a transport hose with an insulating casing for connecting the cooling chamber and the reservoir vessel, and a first and a second end is provided with the coolant hose, a rotatable and thermally insulated connecting element is provided on the first and the second end of the coolant hose each of which coacts with a corresponding connecting element on the cooling chamber and on the reservoir vessel.

It is particularly advantageous, for the transport of coolant from a reservoir vessel to a cooling chamber, if the first and the second end of the coolant hose are respectively provided with a rotatable and thermally insulated connecting element that coacts with a corresponding connecting element on the cooling chamber and on the reservoir vessel.

The transport hose is provided, on both the first and the second end of the coolant hose, with a conical element that coacts with a corresponding counterpart conical element on the reservoir vessel and on the cooling chamber. The conical element or the counterpart conical element can be preloaded with a spring.

The conical element comprises a tube having a conical end; wherein the conical element is preloaded with a spring so that it slides in the longitudinal direction of the transport hose. The thermally insulated connecting element of the coolant hose coacts via a thread with the connecting element on the cooling chamber and on the reservoir vessel.

The connecting element of the coolant hose possesses an internal thread, and the connecting element on the cooling chamber and on the reservoir vessel possesses an external thread. The thermally insulated connecting element of the coolant hose can likewise coact via a bayonet with the connecting element on the cooling chamber and/or on the reservoir vessel.

Further advantages and advantageous embodiments of the invention may be inferred from the dependent claims, and are the subject matter of the Figures below as well as their descriptions.

### BRIEF DESCRIPTION OF THE DRAWINGS

In the individual Figures:

FIG. 1 is a perspective view of a system made up of a reservoir vessel for coolant and a cooling chamber;

FIG. 2 is a view in cross section of an end of the coolant hose and of a connecting element on the cooling chamber or on the reservoir vessel;

FIG. 3 is a perspective view of an end of the coolant hose and of the connecting element on the reservoir vessel; and

FIG. 4 is a further perspective view, from a different viewing angle, of an end of the coolant hose and of the connecting element on the reservoir vessel.

### DETAILED DESCRIPTION OF THE INVENTION

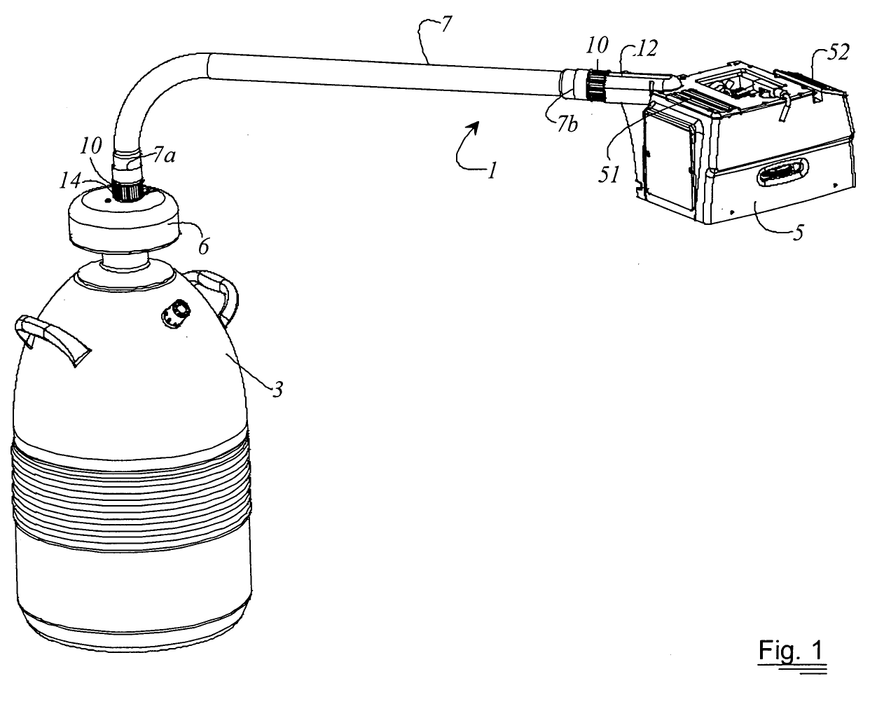

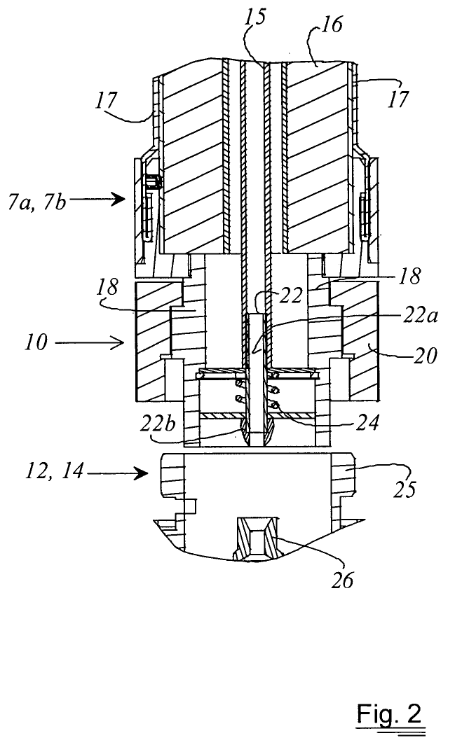

FIG. 1 is a perspective view of a system 1 made up of a cooling chamber 5 and a reservoir vessel 3 for coolant. Cooling chamber 5 is configured in such a way that it receives the region of the sample holder and knife holder of a microtome or ultramicrotome (not depicted), so that a low temperature can be established. Reservoir vessel 3 is a Dewar. A pump 6, which projects into reservoir vessel 3 or the Dewar, sits on reservoir vessel 3. A coolant hose 7 connects reservoir vessel 3 to cooling chamber 5. Coolant is transported out of reservoir vessel 3 through coolant hose 7 to cooling chamber 5. Cooling chamber 5 comprises supports 51 and 52 for a user's hands when he or she is operating the microtome or ultramicrotome equipped with cooling chamber 5. Coolant hose 7 comprises a transport hose and an insulating casing (see FIG. 2). Instead of cooling chamber 5, it is also possible to attach other chambers for sample preparation that require a low temperature for sample preparation. Coolant hose 7 comprises a first end 7a and a second end 7b. First end and second end 7a, 7b of coolant hose 7 are provided with a rotatable and thermally insulating connecting element 10. Thermally insulating connecting element 10 is identical on first and on second end 7a, 7b. Connecting element 10 coacts with a corresponding connecting element 12 on cooling chamber 5, and with a corresponding connecting element 14 on reservoir vessel 3.

FIG. 2 is a view in cross section of an end 7a or 7b of coolant hose 7, and of a connecting element 12 or 14 on cooling chamber 5 or on reservoir vessel 3. Coolant hose 7 is constructed from a transport hose 15 and an insulating casing 16. Insulating casing 16 is equipped, on the outer side of coolant hose 7, with a protective sheath 17. Insulating casing 16 is equipped with a connecting element 10. Connecting element 10 comprises an inner element 18 in which transport hose 15 is guided in such a way that it is spaced away from inner element 18. Between inner element 18 and transport hose 15 is air, which is known to possess an insulating property. Inner element 18 is provided with an outer threaded ring 20 that coacts with the corresponding connecting element 12 on cooling chamber 5 and on the corresponding connecting element 14 on reservoir vessel 3. The two ends of transport hose 15 are each equipped with a conical element 22. Conical element 22 can be preloaded with a spring 24. Conical element 22 comprises a tube 22a and a conical end 22b. Conical element 22 is preloaded with spring 24 so that it slides, with tube 22a, in the longitudinal direction of transport hose 15. Upon connection of transport hose 15 to connecting element 12 or 14 on cooling chamber 5 or on reservoir vessel 3, threaded ring 20 is screwed onto a counterelement 25 on connecting element 12 or 14 on cooling chamber 5 or on reservoir vessel 3. In this context, conical element 22 preloaded by spring 24 is pressed onto a counterpart conical element 26. As a result of the preloading of conical element 22 and the pressure of conical end 22b onto counterpart conical element 26, a leakproof connection is achieved between transport hose 15 and reservoir vessel 3 or cooling chamber 5. Suitable materials are used for threaded ring 20 to ensure that threaded ring 20 remains almost at room temperature, so that it can be grasped or disengaged by the user at any time.

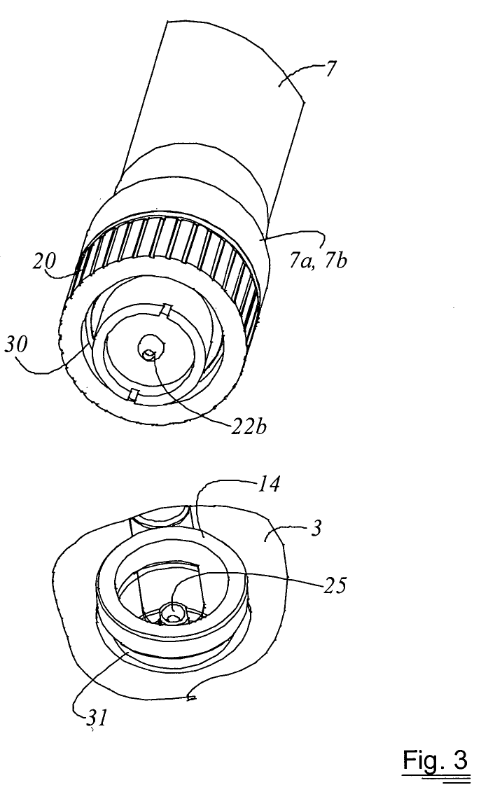

FIG. 3 is a perspective view of an end 7a or 7b of coolant hose 7 and of connecting element 14 on reservoir vessel 3. The connection between reservoir vessel 3 and coolant hose 7 is open. In order to close the connection, the rotatable threaded ring 20 is screwed, with internal thread 30, onto the oppositely located connecting element 14 of reservoir vessel 3. Connecting element 14 possesses an external thread 31 that coacts with internal thread 30. Upon closing, the sealing conical end 22b that is mounted on transport hose 15 is pressed onto counterpart conical element 26.

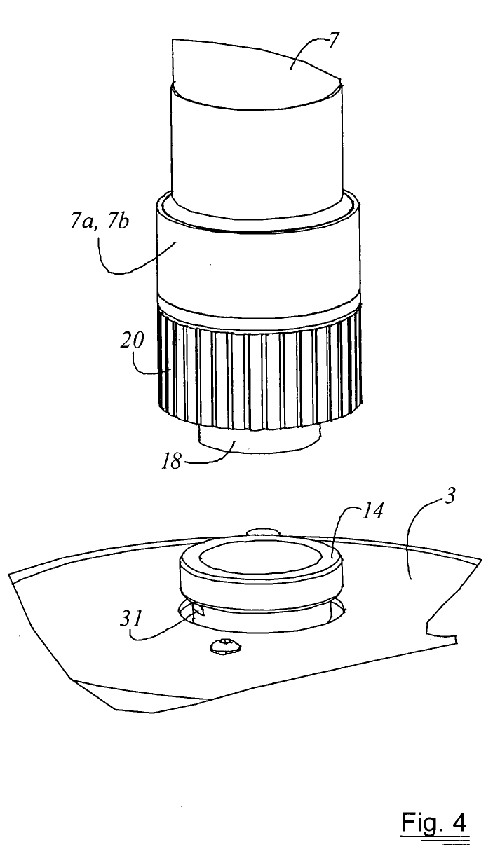

FIG. 4 is a further perspective view, from a different viewing angle, of an end of coolant hose 7 and of connecting element 14 on reservoir vessel 3. In order to close the connection between reservoir vessel 3 and coolant hose 7, the rotatable threaded ring 20 is screwed onto external thread 30 on the oppositely located connecting element 14 of reservoir vessel 3. Connecting element 10 encompasses internal element 18, which is introduced into connecting element 14 on reservoir vessel 3 and thus constitutes a guide as the connection between coolant hose 7 and reservoir vessel 3 is created. A secure connection between coolant hose 7 and reservoir vessel 3 or coolant chamber 5 is then achieved by rotating threaded ring 20.

1. A coolant hose for the transport of coolant from a reservoir vessel to a cooling chamber, comprises a transport hose with an insulating casing, a first and a second end is provided with the coolant hose, a rotatable and thermally insulated connecting element is provided on the first and the second end of the coolant hose each of which coacts with a corresponding connecting element on the cooling chamber and on the reservoir vessel.

2. The coolant hose as defined in claim 1, wherein the transport hose is provided, on both the first and the second end of the coolant hose, with a conical element that coacts with a corresponding counterpart conical element on the reservoir vessel and on the cooling chamber.

3. The coolant hose as defined in claim 2, wherein the conical element or the counterpart conical element is preloaded with a spring.

4. The coolant hose as defined in claim 2, wherein the conical element comprises a tube having a conical end; and the conical element is preloaded with a spring so that it slides in the longitudinal direction of the transport hose.

5. The coolant hose as defined in claim 1, wherein the thermally insulated connecting element of the coolant hose coacts via a threaded ring with the connecting element on the cooling chamber and/or on the reservoir vessel.

6. The coolant hose as defined in claim 5, wherein the connecting element of the coolant hose encompasses a rotatable threaded ring having an internal thread, and the connecting element on the cooling chamber and on the reservoir vessel encompasses an external thread.

7. The coolant hose as defined in claim 1, wherein the thermally insulated connecting element of the coolant hose coacts via a bayonet with the connecting element on the cooling chamber and on the reservoir vessel.

8. The coolant hose as defined in claim 1, wherein the first and the second end of the coolant hose are each equipped with an identical connecting element.

9. The coolant hose as defined in claim 1, wherein the reservoir vessel is a Dewar vessel for liquid nitrogen.

10. The coolant hose as defined in claim 1, wherein the cooling chamber is suitable for a microtome or an ultramicrotome.

11. A system for providing coolant to a cooling chamber, comprising: a reservoir vessel, a transport hose with an insulating casing for connecting the cooling chamber and the reservoir vessel, and a first and a second end is provided with the coolant hose, a rotatable and thermally insulated connecting element is provided on the first and the second end of the coolant hose each of which coacts with a corresponding connecting element on the cooling chamber and on the reservoir vessel.

12. The system as defined in claim 11, wherein the transport hose is provided, on both the first and the second end of the coolant hose, with a conical element that coacts with a corresponding counterpart conical element on the reservoir vessel and on the cooling chamber.

13. The system as defined in claim 12, wherein the conical element or the counterpart conical element is preloaded with a spring.

14. The system as defined in claim 12, wherein the conical element comprises a tube having a conical end; and the conical element is preloaded with a spring so that it slides in the longitudinal direction of the transport hose.

15. The system as defined in claim 11, wherein the thermally insulated connecting element of the coolant hose coacts via a threaded ring with the connecting element on the cooling chamber and/or on the reservoir vessel.

16. The system as defined in claim 15, wherein wherein the connecting element of the coolant hose encompasses a rotatable threaded ring having an internal thread, and the connecting element on the cooling chamber and on the reservoir vessel encompasses an external thread.

17. The system as defined in claim 11, wherein the thermally insulated connecting element of the coolant hose coacts via a bayonet with the connecting element on the cooling chamber and on the reservoir vessel.

18. The system as defined in Claim 11, wherein the first and the second end of the coolant hose are each equipped with an identical connecting element.

19. The system as defined in Claim 11, wherein the reservoir vessel is a Dewar vessel for liquid nitrogen.

20. The system as defined in claim 11, wherein the cooling chamber is suitable for a microtome or an ultramicrotome.
